(19) United States
(12) Patent Application Publication
(10) Pub. No.: US 2026/0180326 A1
(43) Pub. Date: Jun. 25, 2026

(54) METHOD AND APPARATUS FOR SUPPLYING POWER BASED ON DEGREE OF IMPORTANCE OF LOAD

(71) Applicant: HANWHA SOLUTIONS CORPORATION, Seoul (KR)

(72) Inventors: Youn Jong KANG, Seoul (KR); Su Chang LEE, Seoul (KR); Jeong hun WOO, Seoul (KR); Seung Woo SHIN, Seoul (KR); Ji Won JUNG, Seoul (KR); Gyeong Il KIM, Seoul (KR)

(73) Assignee: HANWHA SOLUTIONS CORPORATION, Seoul (KR)

(21) Appl. No.: 19/341,209

(22) Filed: Sep. 26, 2025

(30) Foreign Application Priority Data
Dec. 24, 2024 (KR) 10-2024-0196303

(51) Int. Cl. H02J 3/00; H02J 3/28; H02J 3/38

(52) U.S. Cl. CPC H02J 3/007; H02J 3/003; H02J 3/28; H02J 3/381; H02J 2101/24; H02J 2105/51; H02J 2105/54

(57) ABSTRACT

An apparatus includes at least one memory and at least one processor, in which the at least one processor is configured to derive an amount of power suppliable to a plurality of loads based on state information of at least one power supply source, determine a degree of importance of each of the plurality of loads based on at least one of information about the plurality of loads or environmental information, and supply power to at least one of the plurality of loads based on the degree of importance.

### CROSS-REFERENCE TO RELATED APPLICATION

This application is based on and claims priority under 35 U.S.C. § 119 to Korean Patent Application No. 10-2024-0196303, filed on Dec. 24, 2024, in the Korean Intellectual Property Office, the disclosure of which is incorporated by reference herein in its entirety.

### BACKGROUND

### 1. Field

The present disclosure relates to a method and apparatus for supplying power, based on a degree of importance of a load.

### 2. Description of the Related Art

Recently, as interest in eco-friendly energy technology increases, facilities of photovoltaic power generation systems are also increasing.

However, regulations related to photovoltaic power generation sometimes result in a disconnection between a grid and a power supply system, causing insufficient power supply to loads.

In the present disclosure, degrees of importance of the loads may be determined by using information about the loads, environmental information, information related to power supply sources, etc., and power may be supplied according to the degrees of importance of the loads.

### SUMMARY

The present disclosure provides a method and apparatus for supplying power, based on a degree of importance of a load. The present disclosure also provides a computer-readable recording medium having recorded thereon a program for executing the method on a computer. The technical problems of the present disclosure are not limited to the aforementioned technical features, and other unstated technical problems may be inferred from embodiments of the disclosure below.

According to an aspect of the present disclosure, a method of supplying power, based on a degree of importance of a load includes deriving an amount of power suppliable to a plurality of loads, based on state information of at least one power supply source, determining a degree of importance of each of the plurality of loads, based on at least one of information about the plurality of loads or environmental information, and supplying power to at least one of the plurality of loads, based on the degree of importance.

According to another aspect of the present disclosure, an apparatus for supplying power, based on a degree of importance of a load includes a memory in which at least one program is stored and at least one processor configured to perform the at least one program, in which the at least one processor is configured to derive an amount of power suppliable to a plurality of loads, based on state information of at least one power supply source, determine a degree of importance of each of the plurality of loads, based on at least one of information about the plurality of loads or environmental information, and supply power to at least one of the plurality of loads, based on the degree of importance.

A computer-readable recording medium according to another aspect of the present disclosure includes a recording medium having recorded thereon a program for executing the above-described method on a computer.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a view for schematically describing a power supply system;

FIG. 2 is a view for describing an example of a method of supplying power, based on a degree of importance of a load according to an embodiment;

FIG. 3 is a structural diagram for describing an example of a method of supplying power, based on a degree of importance of a load according to an embodiment;

FIG. 4 is a flowchart for describing an example of a method of supplying power, based on a degree of importance of a load according to an embodiment;

FIG. 5 is a view for describing an example of a method of deriving the amount of power that may be supplied to a plurality of loads according to an embodiment;

FIG. 6 is a view for describing another example of a method of deriving the amount of power that may be supplied to a plurality of loads according to an embodiment;

FIG. 7 is a view for describing an example of a method of determining degrees of importance of a plurality of loads according to an embodiment.

FIG. 8 is a view for describing an example of a method of determining a power supply order of each of a plurality of loads according to an embodiment.

FIG. 9 is a view for describing an example of a method of supplying power to at least one of a plurality of loads according to an embodiment; and

FIG. 10 is a view for describing an example of a method of controlling a load controller according to an embodiment.

### DETAILED DESCRIPTION

The terms used in the embodiments are general terms that are currently widely used as much as possible, but may vary depending on the intention or precedent of a person working in the art, the emergence of new technology, etc. In addition, in a specific case, the applicant voluntarily may select terms, and in this case, the meaning of the terms may be disclosed in a corresponding description part of the present disclosure. Thus, the terms used in herein should be defined not by the simple names of the terms but by the meaning of the terms and the contents throughout the specification.

Throughout the entirety of the specification of the present disclosure, when it is assumed that a certain part includes a certain component, the term ‘including’ means that a corresponding component may further include other components unless specially described to the contrary. The term used herein such as “˜unit” or “˜module” indicates a unit for processing at least one function or operation, and may be implemented in hardware, software, or in a combination of hardware and software.

In addition, terminology, such as “first” or “second” used herein, can be used to describe various components, but the components should not be limited by the terms. These terms are used to distinguish one component from another component.

Hereinafter, the disclosure will be described in detail with reference to the attached drawings. However, the embodiments may be implemented in various forms, and are not limited to examples described herein.

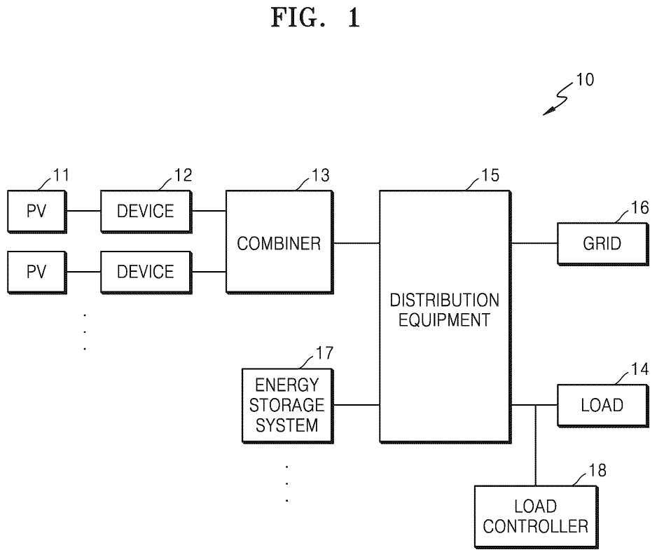

Referring to FIG. 1, a power supply system 10 may include a photovoltaic module 11, a device 12, a load 14, and/or distribution equipment 15. The power supply system 10 may be connected to an external power grid 16.

At least one photovoltaic module 11 may be installed on the roof or exterior wall of a building to generate power. A plurality of photovoltaic modules 11 may be connected to form a photovoltaic module array.

The photovoltaic module 11 may be connected to the device 12. For example, at least one device 12 may be connected to each photovoltaic module 11. In an example, in case that one device 12 is connected to each photovoltaic module 11, the number of devices 12 constituting the power supply system 10 may be equal to the number of photovoltaic modules 11.

The device 12 may be a power conditioning system or power conversion system (PCS) that performs power conversion for power generated from the photovoltaic module 11. For example, the device 12 may perform selected conversion on the power generated from the photovoltaic module 11 and supply the converted power to other components of the power supply system 10 (e.g., the power grid 16 and/or the load 14, etc.).

The device 12 may be a module level power electronics (MLPE) device. For example, the device 12 may be an optimizer or a micro inverter (MI).

In an example, in case that the device 12 is an optimizer, the device 12 may regulate the power produced from the photovoltaic module 11 and output the regulated power to an inverter (e.g., a string inverter). Current converted by the inverter (e.g., direct current converted into alternating current) may be output to the power grid 16 or the load 14.

In another example, in case that the device 12 is a micro inverter, the device 12 may convert the power generated from the photovoltaic module 11 (e.g., convert direct current into alternating current). The current converted in the device 12 may be output to the power grid 16 or the load 14.

Depending on a need, the power supply system 10 may further include a combiner 13. At least a part of the devices 12 may be connected to a distribution equipment 15 through the combiner 13. For example, power output from a plurality of devices 12 may be combined into one output by the combiner 13 and supplied to the distribution equipment 15.

The device 12 and the distribution equipment 15 may be connected by a power path that does not include the combiner 13, and at least one device 12 may be connected to the distribution equipment 15 by a power path that does not include the combiner 13, and at least one other device 12 may be connected to the distribution equipment 15 through the combiner 13.

The combiner 13 may control voltage, current and/or power output from the device 12 according to a power supply state of the photovoltaic module 11, the device 12, and/or the power grid 16, and set the operation mode of the combiner 13 to a diagnosis mode or a driving mode, etc.

The combiner 13 may include an energy management system (EMS) that controls the operation of the combiner 13. The EMS may control voltage, current and/or power supplied to or output from the device 12 according to a power supply state of the photovoltaic module 11, the device 12, and/or the power grid 16, and set the operation mode of the combiner 13 to the diagnosis mode or the driving mode, etc.

The load 14 may refer to an object that is installed in an electricity receiver such as a house, commercial facility, factory, etc., and operates by receiving at least one of energy generated by the photovoltaic module 11, energy stored in an energy storage device 17, and/or energy supplied from the power grid 16. For example, in case that the electricity receiver receiving power is a house, the load 14 may include home appliances such as a washing machine, a refrigerator, a TV, etc.

The power grid 16 may include an infrastructure system for generating, transmitting, and distributing power. For example, the power grid 16 may include the infrastructure system such as power plants, substations, power lines, etc. The power grid 16 may transmit electric energy generated at a power plant to the power supply system 10 or transmit surplus power generated in the power supply system 10 to the outside of the power supply system 10.

For example, commercial power transmitted from the power grid 16 through a power pole may be supplied to the power receiver through a transformer. The power supply system 10 may be implemented as an off-grid system that is not connected to the power grid 16.

The power supply system 10 may further include at least one energy storage device 17. Depending on a need, the power supply system 10 may further include a plurality of energy storage devices 17. The energy storage device 17 may receive and store power generated by the photovoltaic module 11 and/or power transmitted from the power grid 16. The energy storage device 17 may efficiently supply power by storing power and supplying power to the load 14 when the load 14 needs the power.

The energy storage device 17 may include a battery that stores power and a power conversion module. The battery include a battery management system (BMS) that monitors SOC, SOH, voltage and/or current of the battery, performs diagnosis on the battery, and performs a safety function such as current cutoff, etc.

The power conversion module may be a PCS that performs conversion between battery-side power and opposite-side power. For example, the PCS may convert between direct current on the battery side and alternating current on the opposite side. As an example, the PCS may include a bidirectional DC-DC converter that is connected to the battery to convert voltage, and a bidirectional inverter that connects the DC-DC converter to the outside of the energy storage device 17.

The energy storage device 17 may further include an EMS that controls the operation of the energy storage device 17. The EMS may control the voltage, current and/or power supplied to or output from the energy storage device 17 according to the power supply state of the battery and/or the power grid 16, and may set the operation mode of the energy storage device 17 to the diagnosis mode or the driving mode, etc.

Depending on a need, the EMS coupled to a selected component of the power supply system 10 may not only control the operation of a selected component, but may also control operations of other components of the power supply system 10. For example, the EMS coupled to the combiner 13 or the EMS coupled to the energy storage device 17 may control both the operation of the combiner 13 and the operation of the energy storage device 17.

A load controller 18 may mean a device that manages and controls power supplied from the distribution equipment 15 to the load 14. For example, the load controller 18 may supply or cut off power to the load 14, based on information related to the power supplied from the distribution equipment 15 and/or information about the load 14.

The distribution equipment 15 may provide electrical connection between components of the power supply system 10 and may control a power flow of the power supply system 10. For example, the distribution equipment 15 may electrically connect the photovoltaic module 11 and the load 14. As an example, the distribution equipment 15 may be connected to the device 12 connected to the photovoltaic module 11 to electrically connect the photovoltaic module 11 to the load 14. Depending on a need, the distribution equipment 15 may be further connected to at least one of the energy storage device 17 and the power grid 16.

For example, the distribution equipment 15 may be a distribution panel that distributes power within the power supply system 10. As an example, the distribution equipment 15 may be a master service panel (MSP) that distributes the power generated from the photovoltaic module 11 to the load 14, etc.

In another example, the distribution equipment 15 may be a primary controller that performs power distribution within the power supply system and controls each device 12. As an example, the primary controller may include a switch, a circuit breaker, and a control unit. The switch, the circuit breaker and the control unit may each be implemented as an independent device, or at least some of the switch, the circuit breaker and the control unit may be included in a single device.

The primary controller may include a switch that controls electrical connection between components connected to the primary controller, such as the device 12 and the load 14. For example, the primary controller may include a relay, a power semiconductor, etc., that provides or blocks electrical connection to the device 12 and/or the energy storage device 17 depending on the operating state of each component of the power supply system 10.

The primary controller may perform rapid shutdown to stop power generation of the photovoltaic module 11 in an emergency situation such as overcurrent occurrence in the power supply system 10, etc. To this end, the primary controller may include a circuit breaker that blocks connection between the device 12 and the load 14.

The primary controller may include a control unit that generally controls the operation of the primary controller. In addition to the primary controller, the control unit may control the operations of other components of the power supply system 10, such as the device 12, the energy storage device 17, or the like.

The control unit may perform control on the voltage, current and/or power output from or supplied to each component according to the power supply state of the photovoltaic module 11, the device 12, the combiner 13, the load 14, the power grid 16 and/or the energy storage device 17. The control unit may set the operation mode of the primary controller, the device 12 and/or the energy storage device 17 to the diagnosis mode, the driving mode, etc.

For example, the control unit may control the photovoltaic module 11, the device 12, the combiner 13 and/or the energy storage device 17, based on the state of the power supply system 10. As an example, the control unit may control other components of the power supply system 10 by causing the primary controller to communicate with other components of the power supply system 10, e.g., the device 12, etc. Communication between the primary controller and other components of the power supply system 10 may be performed using power line communication (PLC), but the present disclosure is not limited thereto.

As an example, the control unit may control the device 12 according to the power generation state of the photovoltaic module 11. For example, the primary controller may receive a control command from a server that monitors the power generation state of the photovoltaic module 11, and the control unit may control the device 12 according to the control command.

The primary controller may supply power to at least a part of the load 14 in case that power supply from the power grid 16 is not smooth (e.g., in an off-grid situation, etc.). For example, in case that power supply from the power grid 16 is not smooth, the primary controller may preferentially supply power generated from the photovoltaic module 11 and/or power stored in the energy storage device 17 to a backup load that has a relatively high need for stable power supply.

The power supply system 10 may further include an auxiliary power generation device (e.g., a diesel generator, etc.) that generates power in a separate manner other than photovoltaic power generation. For example, the auxiliary power generation device may be further connected to the distribution equipment 15. In case that the primary controller may not be able to correspond to a backup load merely with the photovoltaic module 11 and the energy storage device 17 due to environmental factors such as a time zone or weather, the primary controller may supply the power generated by the auxiliary power generation device to the backup load.

The control unit may be implemented by at least one processor. The processor may process a command of a computer program by performing basic arithmetic, logic, and input/output operations. Here, the command may be provided from an internal memory of the primary controller or from an external device. The processor may generally control operations of other components included in the primary controller.

The processor may perform at least some of data analysis, processing, and result information generation for performing the above-described operations using at least one of machine learning, a neural network, or a deep learning algorithm as a rule-based or artificial intelligence algorithm. Examples of neural networks may include architecture-based neural network models such as a convolutional neural network (CNN), a deep neural network (DNN), and a recurrent neural network (RNN).

For example, the processor may be implemented as an array of a plurality of logic gates, or may be implemented as a combination of a general-purpose microprocessor and a memory storing a program executable on the microprocessor. For example, a processor may include a general purpose processor, a central processing unit (CPU), a microprocessor, a digital signal processor (DSP), a controller, a microcontroller, a state machine, etc.

In some environments, the processor may include an application specific integrated circuit (ASIC), a programmable logic device (PLD), a field programmable gate array (FPGA), etc. For example, the processor may refer to a combination of a DSP and a microprocessor, a combination of a plurality of microprocessors, a combination of one or more microprocessors combined with a DSP core, or a combination of processing devices such as any combination of other such components.

By combining at least some of the components described above, the power supply system 10 may be implemented in various forms.

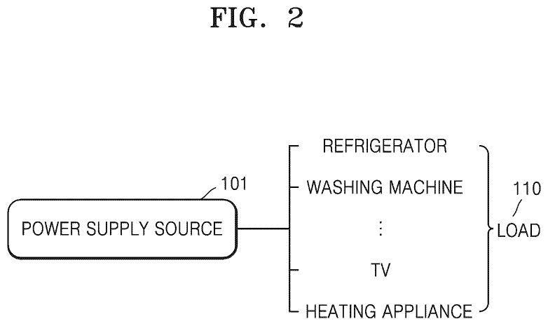

FIG. 2 is a view for describing an example of a method of supplying power, based on a degree of importance of a load according to an embodiment.

Referring to FIG. 2, a power supply source 101 may supply power to loads 110.

For example, the power supply source 101 may include a grid, a photovoltaic (PV) module, and an energy storage system (ESS).

The power supply source 101 may include not only photovoltaic power generation energy, but also any renewable energy sources. The power supply source 101 may include, but is not limited to, all renewable energy sources such as photovoltaic power generation energy, wind power generation energy, hydroelectric power generation energy, geothermal power generation energy, and tidal power generation energy. The power supply source 101 may also include a fuel cell.

Here, the load 110 may mean various types of devices that consume power, and in particular, may mean home appliances, heating/cooling devices, and light bulbs at home, and may mean devices that consume power in any place as well as at home. The grid may mean a power network capable of optimizing energy efficiency by exchanging power bidirectionally. The PV module may mean a device that converts photovoltaic energy into electricity. The ESS may be a system that stores power and may supply power to a device that requires power in case that power is needed.

In case that power supply is required depending on the operations of the loads 110, the power supply source 101 may supply power to the loads 110 requiring power supply.

However, due to selected regulations related to eco-friendly energy generation, the amount of eco-friendly energy generated may become irregular, and as a result, the power supply source 101 may fail to supply power to all the loads 110.

Accordingly, a degree of importance of each load 110, such as a refrigerator, a washing machine, a TV, a heating appliance, etc., may be determined, and the power supply source 101 may supply power according to the determined degree of importance, thereby ensuring efficient power supply.

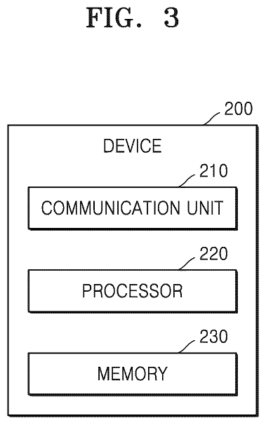

FIG. 3 is a structural diagram for describing an example of a method of supplying power, based on a degree of importance of a load according to an embodiment.

Referring to FIG. 3, a device (hereinafter, referred to as ‘device’) 200 that supplies power, based on a degree of importance of a load may include a communication unit 210, a processor 220, and a memory 230. Components related to the embodiment are shown in the device 200 of FIG. 2. Accordingly, it would be obvious to those of ordinary skill in the art that other general-purpose components may be included in addition to the components shown in FIG. 2.

The communication unit 210 may include one or more components that enable wired/wireless communication with an external server or external device. For example, the communication unit 210 may include a short-range communication unit (not shown) and a mobile communication unit (not shown) for communication with an external server or an external device.

The processor 220 may control the overall operation of the device 200. For example, the processor 220 may control an input unit (not shown), a display (not shown), the communication unit 210, the memory 230, etc., by executing programs stored in the memory 230.

The processor 220 may be implemented using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

The processor 220 may control the operation of the device 200 by executing the programs stored in the memory 230. As an example, the processor 220 may perform at least a part of the method of supplying power, based on a degree of importance of a load, described with reference to FIGS. 3 through 9.

The memory 230 may be hardware that stores various data processed in the device 200 and may store programs for processing and control of the processor 220.

For example, in the memory 230 may be stored various data, such as power information, e.g., the amount of power generation, environmental information, temperature, the current amount of power, the predicted amount of power consumption, the stored amount of power, the mobile amount of power, and the amount of power consumption; weather information, e.g., a wind speed, the amount of rainfall, the amount of snowfall, sunrise/sunset times, etc.; and data generated according to the operation of the processor 220. The memory 230 may also store an operating system (OS) and at least one program (e.g., a program required for the processor 220 to operate, etc.).

The memory 230 may include random access memory (RAM) such as dynamic random access memory (DRAM), static random access memory (SRAM), etc., read-only memory (ROM), electrically erasable programmable read-only memory (EEPROM), CD-ROM, Blu-ray or other optical disk storages, hard disk drive (HDD), solid state drive (SSD), flash memory, etc.

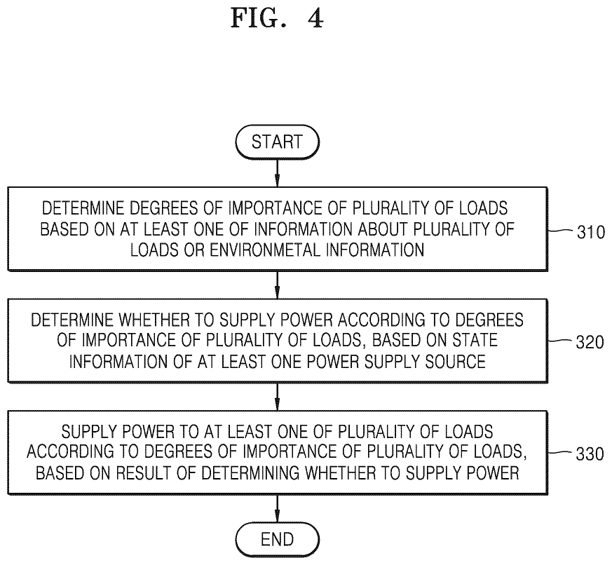

FIG. 4 is a flowchart for describing an example of a method of supplying power, based on a degree of importance of a load according to an embodiment.

Referring to FIG. 4, a method of supplying power, based on a degree of importance of a load may include operations 310 to 330. However, the present disclosure is not limited thereto, and other general operations than the operations illustrated in FIG. 3 may be further included in the method of supplying power, based on the degree of importance of the load. As described above with reference to FIGS. 1 and 2, at least one of the operations of the flowchart shown in FIG. 3 may be processed by the processor.

In operation 310, the processor may derive the amount of power that may be supplied to a plurality of loads, based on state information of at least one power supply source. At least one power source may include a grid, at least one PV module, and an ESS. At least one power source may also include any renewable energy, a fuel cell, etc., as well as the above-described grid, PV modules, and ESS.

In the present disclosure, for convenience of a description, the power supply source is described as including a PV module and an ESS, but the present disclosure is not limited thereto, and it would be obvious to those of ordinary skill in the art that the power supply source may include any renewable energy sources, fuel cells, etc.

For example, the processor may obtain connection state information of the grid by determining whether the grid is connected to the power supply system, and determine whether power is supplied to the plurality of loads, based on the connection state information of the grid.

For example, the processor may obtain information about power that may be supplied to the power supply system by at least one PV module and an ESS, and determine whether to supply power to the plurality of loads, based on the information about the power that may be supplied.

In operation 320, the processor may determine a degree of importance of each of the plurality of loads, based on at least one of information about the plurality of loads or environmental information.

For example, information about the plurality of loads may include time period information about a period of time for which power is required to be supplied to each of the plurality of loads in a preset time period, time point information about a point in time at which power is supplied to each of the plurality of loads, and information about the amount of power required for each of the plurality of loads, and the environmental information may include temperature information and weather information.

In operation 330, the processor may supply power to at least one of the plurality of loads, based on their degrees of importance.

For example, the processor may determine the order of power supply to each of the plurality of loads, based on their degrees of importance.

The processor may supply power to at least one of the plurality of loads by controlling the load controller, based on any one of a PLC scheme or a wireless communication scheme. Specifically, the processor may control the load controller to control the operation of a switch connected to each of the plurality of loads.

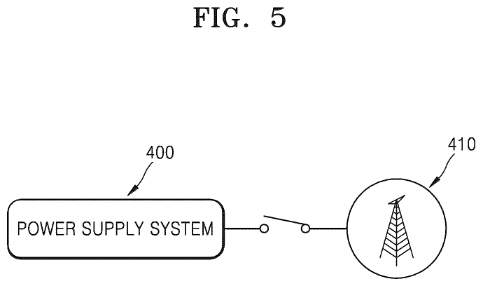

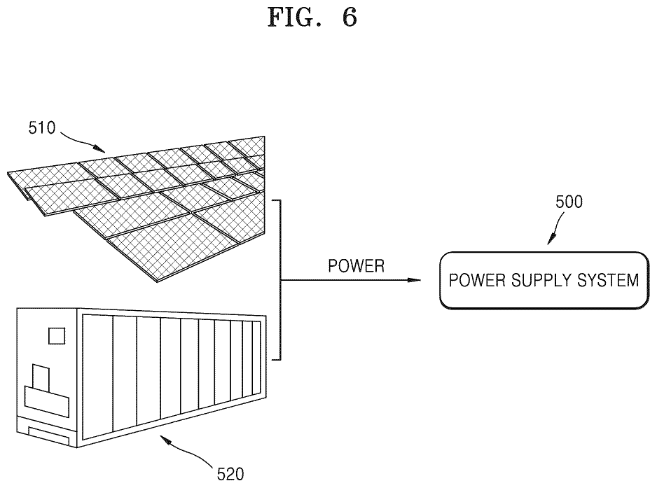

FIG. 5 is a view for describing an example of a method of deriving the amount of power that may be supplied to a plurality of loads according to an embodiment, and FIG. 6 is a view for describing another example of a method of deriving the amount of power that may be supplied to a plurality of loads according to an embodiment.

Hereinafter, referring to FIGS. 5 and 6, examples of a method, performed by a processor, of deriving the amount of power that may be supplied to the plurality of loads will be described.

Referring to FIG. 5, the processor may obtain connection state information between a power supply system 400 and a grid 410.

For example, the processor may derive the amount of power that may be supplied to a plurality of loads, based on state information of at least one power supply source.

For example, the processor may determine whether the grid 410 is connected to the power supply system 400 to obtain connection state information of the grid 410, and derive the amount of power that may be supplied to the plurality of loads, based on the connection state information of the grid 410.

The processor may determine whether the grid 410 is connected to the power supply system 400 and, based on a result of determining whether the grid 410 is connected, derive the amount of power that may be supplied to the plurality of loads.

As an example, the processor may obtain the connection state information of the grid 410 indicating that the grid 410 is connected to the power supply system 400. As the grid 410 is connected to the power supply system 400, the processor may derive the amount of power that may be supplied by power supply sources including the grid 410.

As another example, the processor may obtain the connection state information of the grid 410 indicating that the grid 410 is not connected to the power supply system 400. As the grid 410 is not connected to the power supply system 400, the processor may derive the amount of power that may be supplied by power supply sources excluding the grid 410.

Referring to FIG. 6, the processor may derive the amount of power that may be supplied by a PV module 510 and an ESS 520 to a power supply system 500.

For example, the processor may obtain information about power that may be supplied to the power supply system 500 by at least one PV module 510 and an ESS 520, and derive the amount of power that may be supplied to the plurality of loads, based on information about power that may be supplied.

For example, the processor may obtain the amount of power generated in real time from the PV module 510. The processor may obtain the amount of power previously stored in the ESS 520.

Thus, the processor may derive the amount of power that may be supplied to the plurality of loads, based on whether a grid is connected to the power supply system 500.

As an example, in case that the grid is connected to the power supply system 500, the processor may derive the amount of power that may be supplied to the plurality of loads by using the amount of power obtained from the grid, the amount of power generated in real time from the PV module 510, and the amount of power previously stored in the ESS 520.

As another example, in case that the grid is not connected to the power supply system 500, the processor may derive the amount of power that may be supplied to the plurality of loads by using the amount of power generated in real time from the PV module 510 and the amount of power previously stored in the ESS 520.

The processor may determine a degree of importance of each of the plurality of loads, based on at least one of information about the plurality of loads or environmental information.

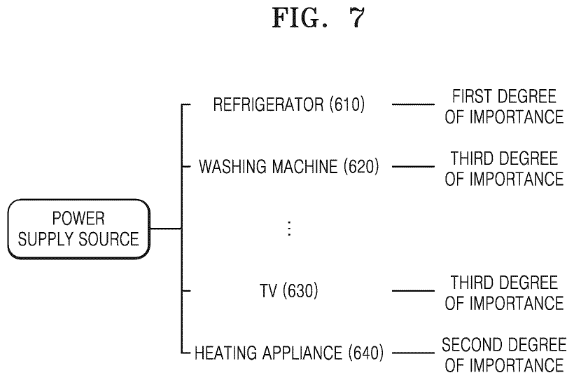

FIG. 7 is a view for describing an example of a method of determining degrees of importance of a plurality of loads according to an embodiment.

Hereinafter, with reference to FIG. 7, an example of a method, performed by the processor, of determining degrees of importance of the plurality of loads will be described.

Referring to FIG. 7, the processor may determine degrees of importance of loads such as a refrigerator 610, a washing machine 620, a TV 630, a heating appliance 640, etc.

For example, the processor may determine the degrees of importance of the plurality of loads, based on at least one of information about the plurality of loads or environmental information.

The information about the plurality of loads may include time period information about a period of time for which power is required to be supplied to each of the plurality of loads in a preset time period, time point information about a point in time at which power is supplied to each of the plurality of loads, and information about the amount of power required for each of the plurality of loads. The processor may obtain information about the plurality of loads, based on history data about when power was supplied to each of the plurality of loads in the past. The processor may obtain the information about the plurality of loads as described above by using power supply information of the plurality of loads in a preset period of time in the past.

The environmental information may include temperature information and weather information. For example, the processor may obtain information about temperature, whether it is day or night, etc., based on temperature sensors, visual information, etc.

The degrees of importance may be divided into a first degree of importance, a second degree of importance, and a third degree of importance, but the present disclosure is not limited thereto, and a lower number may mean a higher degree of importance, and a higher number may mean a lower degree of importance.

A load determined to have a higher degree of importance may be given a higher priority for power supply, while a load determined to have a lower degree of importance may be given a lower priority for power supply.

First, the processor may obtain time period information about a period of time for which power is required to be supplied to each of the plurality of loads in a preset time period.

For example, the processor may determine a degree of importance of each of the plurality of loads, based on the time period information about the period of time for which power is required to be supplied to each of the plurality of loads in a preset time period. In other words, the plurality of loads may require power supply in different periods of time for 24 hours a day. More specifically, the refrigerator 610 may require power supply 24 hours a day, the washing machine 620 may require power supply only 2 hours out of 24 hours, the TV 630 may not require power supply 24 hours a day, and the heating appliance 640 may require power supply only 12 hours out of 24 hours. For convenience of a description, the preset period is described as one day, but the present disclosure is not limited thereto and any period, such as 3 days, 1 week, etc., may be the preset time.

Accordingly, the processor may determine a degree of importance of the refrigerator 610 as the first degree of importance, degrees of importance of the washing machine 620 and the TV 630 as the third degree of importance, and a degree of importance of the heating appliance 640 as the second degree of importance, depending on a period of time for which power supply to each load is required.

The processor may obtain time point information about a point in time at which power is supplied to each of the plurality of loads.

For example, the processor may determine a degree of importance of each of the plurality of loads, based on the time point information about the point in time at which power is supplied to each of the plurality of loads. That is, the plurality of loads may be supplied with power at different points in time for a day. More specifically, the refrigerator 610 may be supplied with power for 24 hours a day, the washing machine 620 may be supplied with power primarily at 10:00 AM, the TV 630 may be supplied with power primarily at 7:00 PM, and the heating appliance 640 may be supplied with power primarily at 11:00 PM.

Thus, the processor may determine a degree of importance of each of the plurality of loads, based on a point in time at which a degree of importance of each of the plurality of loads is determined.

For example, in case that a degree of importance of each of the plurality of loads is determined at 11:00 PM, the processor may determine degrees of importance of the refrigerator 610 and the heating appliance 640 as first degrees of importance, a degree of importance of the washing machine 620 as a third degree of importance, and a degree of importance of the TV 630 as a second degree of importance.

The processor may obtain information about the amount of power required for each of the plurality of loads.

For example, the processor may determine a degree of importance of each of the plurality of loads, based on the information about the amount of power required for each of the plurality of loads. That is, the amount of power required to be supplied to each of the plurality of loads may be different. More specifically, the refrigerator 610 may require 7 units of power, the washing machine 620 may require 3 units of power, the TV 630 may require 1 unit of power, and the heating appliance 640 may require 5 units of power. However, it would be obvious to those of ordinary skill in the art that 1 unit, 3 units, 5 units, and 7 units of power, which are expressed as the amounts of power required for respective loads, are expressed as relative values rather than absolute values.

As an example, the processor may determine a higher degree of importance for a larger amount of power required to be supplied. For example, the processor may determine the degree of importance of the refrigerator 610 as the first degree of importance, the degrees of importance of the washing machine 620 and the TV 630 as the third degree of importance, and the degree of importance of the heating appliance 640 as the second degree of importance.

As another example, the processor may determine a degree of importance, based on a total amount of power that may be supplied by a power supply source. That is, the processor may determine a higher degree of importance of a load for a smaller difference between the total amount of power that may be required to be supplied to the load. Accordingly, in case that the total amount of power that may be supplied by the power supply source is 5, the processor may determine the degree of importance of the heating appliance 640 as the first degree of importance, and the degrees of importance of the refrigerator 610, the washing machine 620, and the TV 630 as the third degree of importance.

For example, the processor may determine the degrees of importance of the plurality of loads, based on the environmental information including the temperature information, seasonal information, and the like.

As an example, in case that the temperature is below a preset first temperature, the processor may determine the degree of importance of the heating appliance 640 as the first degree of importance. As another example, in case that the temperature is at least a preset second temperature, the processor may determine the degree of importance of a cooling appliance (not shown) as the first degree of importance.

The processor may further determine degrees of importance of loads with the same degree of importance, based on various criteria for determining degrees of importance described above, even in case that the degrees of importance of the loads are the same.

Specifically, the processor may determine the degree of importance of the washing machine 620 as the third degree of importance as the washing machine 620 requires 2 hours out of 24 hours, and determine the degree of importance of the TV 630 as the third degree of importance as the TV 630 requires 0 hour out of 24 hours, based on time period information about a period of time for which power is required to be supplied to each of the plurality of loads in a preset time period. The processor may further determine a degree of importance, based on a point in time at which power is supplied to a corresponding load. That is, in case that the processor determines a degree of importance at 8:00 PM, the processor may determine the degree of importance of the TV 630 as a 3-1st degree of importance and the degree of importance of the washing machine 620 as a 3-2nd degree of importance.

The processor may supply power to at least one of the plurality of loads, based on their degrees of importance.

For example, the processor may determine the order of power supply to each of the plurality of loads, based on their degrees of importance.

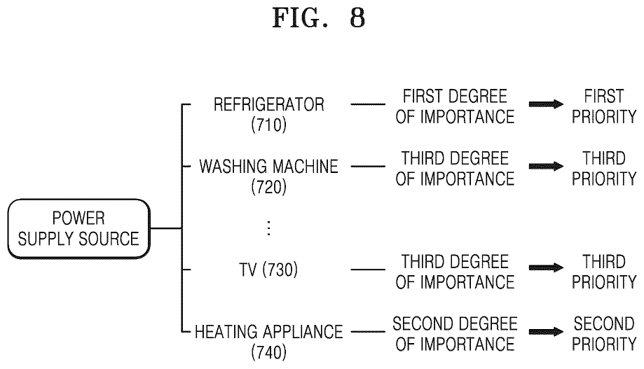

FIG. 8 is a view for describing an example of a method of determining a power supply order of each of a plurality of loads according to an embodiment.

Hereinafter, with reference to FIG. 8, an example of a method, performed by the processor, of determining a power supply order of each of the plurality of loads will be described.

Referring to FIG. 8, the processor may determine a first priority to a third priority as the power supply order of each of the plurality of loads.

For example, the processor may determine a power supply order of each load, based on a degree of importance of each of the plurality of loads. Specifically, the processor may determine a power supply order of a load determined to have a high degree of importance as a higher priority, and the power supply order of a load determined to have a low degree of importance as a lower priority.

Accordingly, the processor may determine the power supply order of a refrigerator 710 determined to have the first degree of importance as the first priority, the power supply orders of a washing machine 720 and a TV 730 determined to have the third degree of importance as the third priority, and the power supply order of a heating appliance 740 determined to have the second degree of importance as the second priority.

Even in case that the loads have the same degree of importance, the processor may determine the power supply order.

For example, as described with reference to FIG. 6, the processor may further determine the degree of importance of a load, based on several criteria for determining a degree of importance.

For example, even in case that the degrees of importance of the washing machine 720 and the TV 730 are the same as the third degree of importance, the processor may determine the degree of importance of the TV 730 as a 3-1st degree of importance and the degree of importance of the washing machine 720 as a 3-2nd degree of importance, based on a point in time at which power is mainly supplied to a corresponding load.

Thus, the processor may determine the power supply order of the TV 730 as a 3-1st priority and the power supply order of the washing machine 720 as a 3-2nd priority.

As a result, the processor may supply power to the plurality of loads according to the determined power supply order.

For example, the processor may supply power to at least one of the plurality of loads by controlling the load controller, based on any one of a PLC scheme or a wireless communication scheme.

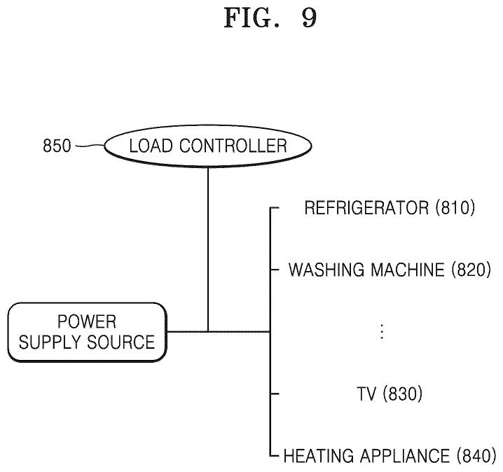

FIG. 9 is a view for describing an example of a method of supplying power to at least one of a plurality of loads according to an embodiment.

Hereinafter, with reference to FIG. 9, an example of a method, performed by the processor, of supplying power to a load using a load controller will be described.

First, referring to FIG. 9, the processor may control a load controller 850 to supply power to a plurality of loads.

For example, the processor may supply power to at least one of the plurality of loads by controlling the load controller, based on any one of a PLC scheme or a wireless communication scheme.

The load controller may mean a device that manages and controls power supplied from a power supply source to a load. PLC may refer to a communication scheme that transmits and receives data or signals using power lines, and wireless communication may refer to a communication scheme that transmits and receives data or signals using radio waves such as Wi-Fi, Zigbee, Lora, etc., Bluetooth, cellular networks, and so forth.

For example, the processor may select an appropriate communication scheme between the PLC scheme and the wireless communication scheme.

As an example, the processor may determine that PLC is a suitable communication scheme, based on the surrounding environment where wireless communication has an obstacle.

For example, the processor may determine that PLC is an appropriate communication scheme in case that there are obstacles such as thick walls, trees, etc., that interfere with communication, making wireless communication difficult. In case that the processor 220 determines that there is a communication situation in which there is a device using a common frequency band, there may be difficulties in wireless communication, such that the processor may determine that PLC is a suitable communication scheme.

As another example, the processor may determine that the wireless communication scheme is a suitable communication scheme, based on the surrounding environment that impedes PLC.

For example, the processor may have difficulty with PLC in case that there is a lot of noise from other electronic devices using the same PLC network, such that the processor may determine that the wireless communication scheme is a suitable communication scheme. The processor may have difficulty with PLC in case that there is significant frequency attenuation due to other network devices using the same PLC network, such that the processor may determine that the wireless communication scheme is a suitable communication method.

Accordingly, the processor may supply power to at least one of the plurality of loads by controlling the load controller using a suitable communication scheme.

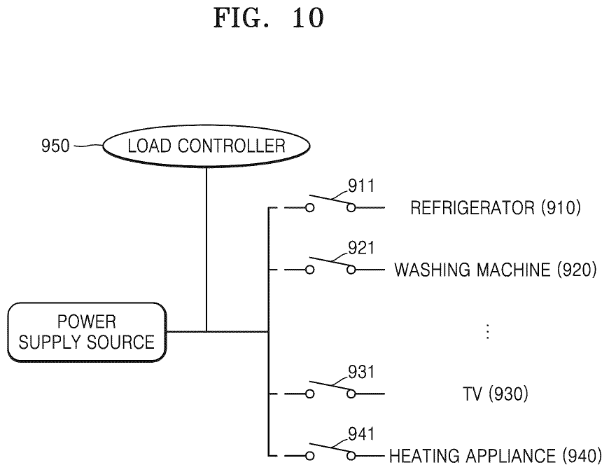

FIG. 10 is a view for describing an example of a method of controlling a load controller according to an embodiment.

Hereinafter, with reference to FIG. 10, an example of a method, performed by the processor, of supplying power to a load by controlling a load controller will be described.

Referring to FIG. 10, the processor may separately control a plurality of switches connecting a power supply source to each of the plurality of loads by controlling a load controller 950.

For example, the processor may control the load controller 950 to control the operation of a switch connected to each of the plurality of loads. The switch may operate as being open or closed, and in case that the switch is open, wires are disconnected and power may not be supplied, and in case that the switch is closed, the wires are connected and power may be supplied.

For example, the processor may control the load controller 950 to control the operation of a switch connected to a load with a higher priority of a power supply order.

Specifically, the processor may supply power by closing, with the highest priority, a switch 911 connected to a refrigerator 910 having a first priority of the power supply order. The processor may supply power by closing, with the lowest priority, a switch 921 connected to a washing machine 920 and a switch 931 connected to a TV 930 having a third priority of the power supply order.

As the degree of importance and power supply priority of each of the plurality of loads may be continuously changed, the processor may continuously open or close switches 911, 921, 931, and 941 respectively connected to the refrigerator 910, the washing machine 920, the TV 930, and the heating appliance 940, based on the continuously changing power supply priority, thereby supplying power to or cutting off power to the plurality of loads.

With the method described in the present disclosure, the degree of importance of each of the plurality of loads may be determined depending on various situations.

By determining the power supply priority according to the degree of importance of each load and supplying power, power may be efficiently supplied to the plurality of loads even in situations where eco-friendly energy generation is limited.

The power supply source and each of the plurality of loads may be connected using the plurality of switches, and each switch may be controlled using the load controller, thereby supplying power to the plurality of loads in the power supply order that changes depending on a situation.

The above-described method may be written as a program executable on a computer, and may be implemented in a general-purpose digital computer that operates the program using a computer-readable recording medium. A data structure used in the above-described method may be recorded on a computer-readable recording medium through various means. The computer-readable recording medium may include a storage medium such as a magnetic storage medium (e.g., read-only memory (ROM), random access memory (RAM), a universal serial bus (USB), a floppy disk, a hard disk, etc.) and an optical read medium (e.g., compact disc (CD)-ROM, a digital versatile disc (DVD), etc.).

It would be understood by those of ordinary skill in the art that the present disclosure may be implemented in a modified form within a scope without departing from the essential characteristics of the present disclosure. Therefore, the disclosed methods should be considered in an illustrative rather than a restrictive sense, and the scope of the claims, not the foregoing description, should be interpreted to include all differences falling within the scope equivalent thereto.

By determining a degree of importance of each load, power may be supplied first to a load having a higher degree of importance.

Moreover, in case that there is not enough power to supply to all the loads, power may be supplied to a load that currently requires power supply.

However, effects obtainable in the embodiments are not limited to the effects mentioned above, and other effects not mentioned above may be clearly understood by those of ordinary skill in the art from the description of the present disclosure.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A method of supplying power, based on a degree of importance of a load, the method comprising:
deriving an amount of power suppliable to a plurality of loads, based on state information of at least one power supply source;
determining a degree of importance of each of the plurality of loads, based on at least one of information about the plurality of loads or environmental information; and
supplying power to at least one of the plurality of loads, based on the degree of importance.

2. The method of claim 1, wherein
the at least one power supply source comprises a grid, and
the deriving of the amount of power comprises:
obtaining connection state information of the grid by determining whether the grid is connected to a power supply system; and
deriving the amount of power suppliable to the plurality of loads, based on the connection state information of the grid.

3. The method of claim 1, wherein
the at least one power source comprises at least one photovoltaic (PV) module and an energy storage system (ESS), and
the deriving the amount of power comprises:
obtaining information about power suppliable to a power supply system by the at least one PV module and the ESS; and
deriving the amount of power suppliable to the plurality of loads, based on the information about the power which is suppliable.

4. The method of claim 1, wherein
the information about the plurality of loads comprises time period information about a period of time for which power is required to be supplied to each of the plurality of loads in a preset time period, time point information about a point in time at which power is supplied to each of the plurality of loads, and information about the amount of power required for each of the plurality of loads, and
the environmental information comprises temperature information and weather information.

5. The method of claim 1, wherein the supplying of the power comprises determining a power supply order of each of the plurality of loads, based on the degree of importance.

6. The method of claim 1, wherein the supplying of the power comprises supplying power to at least one of the plurality of loads by controlling a load controller, based on any one of a power line communication scheme or a wireless communication scheme.

7. The method of claim 6, wherein the supplying of the power comprises controlling the load controller to control an operation of a switch connected to each of the plurality of loads.

8. A computer-readable recording medium having recorded thereon a program for executing the method of claim 1 on a computer.

9. An apparatus for supplying power, based on a degree of importance of a load, the apparatus comprising:
a memory in which at least one program is stored; and
at least one processor configured to perform the at least one program,
the at least one processor is configured to derive an amount of power suppliable to a plurality of loads, based on state information of at least one power supply source, determine a degree of importance of each of the plurality of loads, based on at least one of information about the plurality of loads or environmental information, and supply power to at least one of the plurality of loads, based on the degree of importance.

10. The apparatus of claim 9, wherein the at least one power supply source comprises a grid, and
the at least one processor is further configured to obtain connection state information of the grid by determine whether the grid is connected to a power supply system and derive the amount of power suppliable to the plurality of loads based on the connection state information of the grid.

11. The apparatus of claim 9, wherein the at least one power source comprises at least one photovoltaic (PV) module and an energy storage system (ESS), and
the at least one processor is further configured to obtain information about power suppliable to the power supply system by the at least one PV module and the ESS and derive the amount of power suppliable to the plurality of loads based on the information about the power which is suppliable.

12. The apparatus of claim 9, wherein the information about the plurality of loads comprises time period information about a period of time for which power is required to be supplied to each of the plurality of loads in a preset time period, time point information about a point in time at which power is supplied to each of the plurality of loads, and information about the amount of power required for each of the plurality of loads, and
the environmental information comprises temperature information and weather information.

13. The apparatus of claim 9, wherein the at least one processor is further configured to determine a power supply order of each of the plurality of loads based on the degree of importance.

14. The apparatus of claim 9, wherein the at least one processor is further configured to supply power to at least one of the plurality of loads by controlling a load controller, based on any one of a power line communication scheme or a wireless communication scheme.

15. The apparatus of claim 14, wherein the at least one processor is further configured to control the load controller to control an operation of a switch connected to each of the plurality of loads.
